(19) United States
(12) Patent Application Publication
(10) Pub. No.: US 2009/0303588 A1
(43) Pub. Date: Dec. 10, 2009

(54) MOUNTING DEVICE FOR ACCESSORIES

(76) Inventor: Nick Charlesworth, Newcastle-Upon-Tyne (GB)

Correspondence Address: WINSTEAD PC, P.O. BOX 50784, DALLAS, TX, 75201, US

(21) Appl. No.: 11/659,014

(22) PCT Filed: Jul. 25, 2005
(86) PCT No.: PCT/GB2005/002899

§ 371 Date: Jun. 9, 2009

(30) Foreign Application Priority Data
Jul. 30, 2004 (GB) 0417074.2
Feb. 24, 2005 (GB) 0503749.4

(51) Int. Cl. G02B 7/12; G02B 7/02; A45F 5/00; A42B 1/24

(52) U.S. Cl. 359/481; 359/816; 224/191; 2/209.13

(57) ABSTRACT

A mounting device which includes means for attaching accessories such as binoculars to wearable items such as baseball caps. The binoculars can be tilted to adjust the angle with respect to the cap, slid to adjust the distance of the binoculars from the wearer, and the objectives thereof pivoted to move the same between in-use and out-of-use positions.

The invention to which this application relates is a detachable mounting device for allowing accessories to be mounted to caps or other objects.

Although the following description refers almost exclusively to a device for detachably mounting viewing means in the form of binoculars to a baseball cap, it will be appreciated by persons skilled in the art that the present invention can be used to mount different accessories to other objects.

It is common for viewers of an event, particularly members of a crowd watching a sporting event, to wear headgear such as baseball caps, typically branded to indicate their support for their team.

When viewing such events in a stadium, or from a distant position, viewers often take viewing means in the form of a pair of binoculars with them so that they are able to magnify and view the action more easily. Typically, binoculars are quite heavy and bulky, and as such the viewer is required to support the same with both hands. More recently, smaller and lighter binoculars have been developed, although they still require at least one hand to hold the same in front of the viewer's eyes to be able to look through them.

A further issue with such binoculars is that they can be tiring to physically hold in front of the user's eyes, such that after some time a user may place them on the ground or other surface where they are at risk from being damaged or removed without the owner's position.

In addition, users may also wish to listen to commentary on the event which would normally require a separate receiving device.

An aim of the present invention is to provide a mounting device for headgear that allows different accessories to be mounted thereto.

A further aim is to provide a means for viewing objects which does not require support from the user's hands and yet ensures that the means can be positioned suitably for use.

A further aim of the present invention is for viewing objects at close range with suitable adjusted optical systems.

In a first aspect of the invention, there is provided a mounting device including attachment means which are attachable to or provided as part of a wearable item, and mounting means for attaching at least one accessory thereto to allow said accessory to be supported by the wearable item.

In one embodiment tilting means can be provided which permit the wearer to adjust the angle of an accessory independently to the angle of presentation of the wearable item. Typically sliding means may also be provided to adjust the distance of an accessory from the wearer.

In one embodiment the attachment means and/or the mounting means are any or any combination of straps, clips, hook and loop fastenings, belts, nuts, bolts, screws, clamps, magnets, ties, buttons, catches, studs, docking plates, mounting plates, and/or the like.

In one embodiment the accessories are any or any combination of audio devices, imaging devices, viewing devices, communication means, illumination devices, proximity devices, vibrational devices, mobile telephones, charging devices, power supplies, and/or the like.

Typically the communication means include any or any combination of Bluetooth, infra-red, optical, radio, intercom, or other wired or wireless means, and may be provided in the form of an antenna.

Typically the audio devices include any or any combination of MP3 or other media players and recorders, radios, intercoms, speakers, microphones, headphones, ear mufflers, noise defenders, and/or the like. The speakers include any or any combination of full-cup, half-cup, mini-speaker on boom, and ear bud devices, and the headphones may be noise cancelling.

Typically the imaging devices include any or any combination of cameras, video cameras, electronic displays, and/or the like. The electronic displays may receive signals from a plurality of sources.

Typically the illumination devices include any or any combination of torches, visible light sources, infra-red light sources, ultra-violet light sources, and/or the like.

Typically the proximity device alerts the user audibly and/or by vibration when the wearable item and/or user is in proximity to another user or object. This is helpful for poorly sighted or blind users.

Typically the charging device is in the form of a solar cell panel to enable the user to recharge batteries of an accessory connected thereto.

Typically the accessories are battery powered and function independently of the wearable item and mounting device.

In one embodiment the accessories attach to the docking plate via a docking unit.

In one embodiment the docking unit includes additional batteries.

In a further embodiment the docking unit includes any or any combination of audio amplifiers, data display panels, heads-up displays, wireless remote control links, and/or the like.

Typically the viewing devices include any or any combination of optical and/or electronic viewing means such as binoculars for viewing distant objects, monoculars, magnifying glasses, electronic magnifiers, and/or the like. In the case of nearby objects the viewing means may be single lens assemblies or Fresnel screens or other such devices known to magnify the images of objects. In another embodiment the viewing device is suitable for providing night vision. Infra-red illumination may be provided to allow covert illumination of the view using the night vision device. Optical devices such as lasers may also be provided to help aim the device and/or measure distances

Typically the viewing means can be moved selectively between an in-use position in which the same are positioned in the vicinity of at least one of the wearer's eyes and an out of use position moved away from the in use position.

In one embodiment pivoting means are provided to allow the viewing means to be pivoted between the in-use and out-of-use positions.

Typically said pivotal movement provides the wearer with the means to adjust the position of the viewing means to allow interocular adjustment i.e. accommodate the wearer's eye spacing

In one embodiment, tilting means are provided which permits the wearer to adjust the angle of the viewing device independently to the angle of presentation of the wearable item.

In a further embodiment sliding means are provided to adjust the distance of the viewing device from the wearer's eyes, typically in a substantially horizontal plane.

In one embodiment the pivoting means and/or sliding means and/or tilting means includes a gear driven adjustment system.

In one embodiment the adjustment system is provided with drive means to operate the movements of the same. The drive means could be electrical or mechanical and may also control of any or any combination of switching between in-use and out-of-use positions, spacing of the viewing system relative to the user's eyes, focusing, tilting, zooming, end-stop location, and the like. Typically, electrical drive means could be in the form of an electrical motor with a gear mechanism acting directly on the gears of the adjustment system.

In one embodiment, movement of the viewing means is limited by adjustable end-stops which define the range of movement allowed of the viewing means between in-use and out-of-use positions. The user can adjust the end-stops to appropriate positions such that it is quick and easier to switch the position of the viewing means to predefined positions without further adjustments of the same. The end stops may be in the form of micro-switches connected to the adjustment system, and/or external protrusions located on the external surface of the device. Preferably the end-stops are adjustable to allow inter-ocular spacing adjustments.

In one embodiment the adjustment system is provided with a ratchet mechanism. The ratchet locks the adjustment system when the end-stops are reached, and can be released electronically or manually.

In a further embodiment the adjustment system is provided with a spring loaded mechanism, that permits quick movement between in-use and out-of-use positions and/or vice versa depending on application or the selection by the user. Typically the viewing means are locked by restricting movement of the same, such as by actuation of a latch or button connected thereto, and released by removing the restriction. When released the viewing means is biased towards the in-use position by springs, but is restricted from moving beyond the position required by end-stops.

A spring loaded mechanism is advantageous in comparison to an electrical drive system because it is lightweight and requires no direct power during the switching operation. The durability of the device is increased as the movement of the viewing means between in-use and out-of-use positions is constrained only by a spring. The spring is also more tolerant to knocks and bumps, and the device is therefore less susceptible to physical damage.

Preferably the tension in and/or strength of the spring can be adjusted for optimum performance for different applications.

Preferably the spring may be tensioned by tensioning means, typically in the form of an electric motor and/or hand-powered mechanical means.

In a further embodiment the configuration of the viewing device can be remotely controlled. Typically switching means are provided, which when actuated, signals activation of the spring loaded mechanism. The switching means may be any or any combination of electronic, mechanical, wired or wireless.

Activation of the spring loaded mechanism results in a number of steps, including any or any combination of;
Release of ratchet end-stop so that the viewing means move to the other position under the force of the spring;
Engagement of the other end-stop, locking the viewing means into position;
Motor is switched on to tension the spring, typically after the end-stop locking mechanism is engaged, at which point the motor is switched off.

The system is now ready to repeat. A small logic circuit may be provided to switch the direction of the motor on each usage cycle. The movement of the viewing means may be cushioned to prevent damage to the same and/or the end-stops when the same are brought into contact.

In a yet further embodiment, the pivoting means is located at the end of the viewing means nearest the viewer's eyes. Typically the other end of the viewing means is lifted to move the same into an out-of-use position at an angle to the in-use position. Preferably the pivoting means is as close to eye-level as possible to minimise movement of the eyepiece relative to the viewer's eyes.

In a further embodiment a ball and socket joint is provided to allow a range of movement of the viewing means, including vertical tilting (pivoting), horizontal tilting (sideways movement) and panning (horizontal rotation).

Typically the wearable item is a cap or band to be placed on and at least partially around the wearer's head, and the attachment means is attached to the visor of the cap or band provided thereon.

Preferably, the cap further includes a body section. Typically the body section includes sizing means for adjusting the fit of the cap around a person's head and strengthening means for the visor to thereby ensure the support of the accessory mounted thereto.

The mounting device can be slidably attached to the cap to allow lateral movement of a viewing device connected thereto to the side of the user's eyes thereby moving said viewing device to an out-of-use position. The movement could be linear or circumferential (following the edge of the cap).

In one embodiment, the visor is pivotally connected to the body section of the cap and the attachment means are connected to the visor such that the viewing means is thus moved between in-use and out-of-use positions by adjusting the position of the visor with respect to the portion of the cap which is worn. Alternatively, attachment means are located on a moveable portion of the visor.

In one embodiment the visor and cap are fixedly attached and the various movement mechanisms are mounted directly onto the visor.

Preferably the mounting device is located centrally with respect to the visor and the user's eyes, so that there is no or minimal interference to the line of sight by the mounting device when the viewing means are in their in-use and/or out-of-use positions.

In one embodiment the viewing means includes storage means for storing the view data received by the viewing means.

In a further embodiment, the viewing means comprise two telescopes in which embodiment the viewing means are moved in mirrored arcuate paths. Typically, the viewing means are moved upwards from an in-use position to a substantially parallel out-of-use position.

Preferably, the telescopes comprising the viewing system are connected by a gear system, such that movement of one telescope brings about corresponding movement of the other telescope.

Alternatively, the telescopes can be moved separately, which would allow the user to compensate for uneven mountings of the same.

In one embodiment the viewing means includes focusing means for adjusting the focus of the same.

Typically the viewing means contains a zoom lens means for adjusting the magnification of the viewed object.

In one embodiment the viewing means contains a separate focusing system to adjust the focus on one side of the assembly independently of the other. Typically the focusing system is located in one of the eyepiece or objective lens assemblies and is commonly referred to as dioptre adjustment as it is used to correct differences in performances of the user's eyes.

Typically the viewing range or in focus range of the viewing means is adjustable. In one embodiment the viewing range could be adjusted by altering the optical path length of the viewing means. Typically the optical path length may be adjusted by moving the objective and eyepiece lens assemblies of the viewing means relative to each other. This may be in the form of a centrally mounted wheel adjustment system. Changing the optical path length of the viewing means thereby allows the user to focus on objects at different distances from the wearer.

In a further embodiment the focus means may be positioned in the location of the objective lens casing assembly of the viewing means with any rotary and or linear movement of said casing resulting in a simultaneous change of the optical path length on each of the two telescopes comprising the assembly. Said casing could also accommodate a dioptre adjustment mechanism in one of the eyepiece or objective lens assemblies. Said focus means would permit the wearer to easily adjust the focus whilst maintaining the closest possible siting of the viewing system to the visor.

In a further embodiment a zoom facility may be provided to the optical system with zoom adjustment means positioned in the location of the objective lens casing assembly of the viewing means with any rotary and or linear movement of said casing resulting in a simultaneous movement of the optical zoom mechanism on each of the two telescopes comprising the assembly. Said mechanism would permit the wearer to easily adjust the zoom function whilst maintaining the closest possible siting of the viewing system to the visor.

The range of adjustments and movements as hereinbefore described may be of particular use to users with defects in their vision, such as short-sightedness, as the viewing means can be adjusted for optimum performance and/or comfort.

Preferably the device is manufactured to be as lightweight as possible to avoid discomfort to the user. Further preferably the device is disposable, which may allow the device to be used in sterile or aseptic environments.

In a second aspect of the invention, there is provided a viewing device including viewing means connected to mounting means, and attachment means for attaching the device to a wearable item, chatacterised in that said viewing means can be moved selectively between an in-use position in which the same are positioned in the vicinity of at least one of the wearer's eyes and an out of use position moved away from the in use position.

In one embodiment the viewing means are provided with a camera for the capture of still and/or video images, and/or accompanying sound, situated inside the casing of the viewing means and utilising the objective lens. The objective lens, eyepiece lens and camera lens are so designed that when the viewing means focus is adjusted, a sharp focus image is provided both the eye of the user and the camera sensor. Furthermore, a mechanism may be provided so that the camera image does not rotate when the objectives are hinged to provide inter-ocular spacing adjustment. A camera unit may be located on right and left sides of a binocular viewing means such that right and left images can be captured and processed to provide stereo 3D image capture of both still and/or video images and/or sound.

In a further embodiment one or more cameras may be mounted directly on the viewing device for the capture of images as hereinbefore described.

In a third aspect of the invention, there is provided a wearable item including a cap or band having a body portion to be worn on the head, and a visor protruding from the front end of the cap or band when worn, said visor including attachment means, optical viewing means connected to the attachment means via mounting means, and characterised in that said viewing means can be moved selectively between an in-use position in which the same are positioned in the vicinity of at least one of the wearer's eyes and an out of use position moved away from the in use position.

In a fourth aspect of the invention, there is provided a wearable item including means for attaching one or more accessories thereto, said accessories including any or any combination of viewing, imaging and audio devices

Specific embodiments of the invention are now described wherein:—

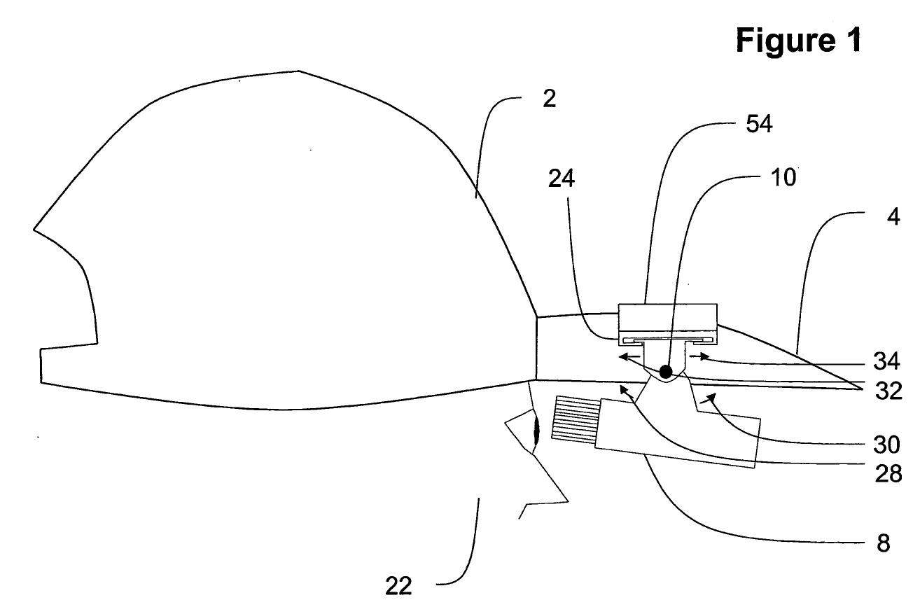

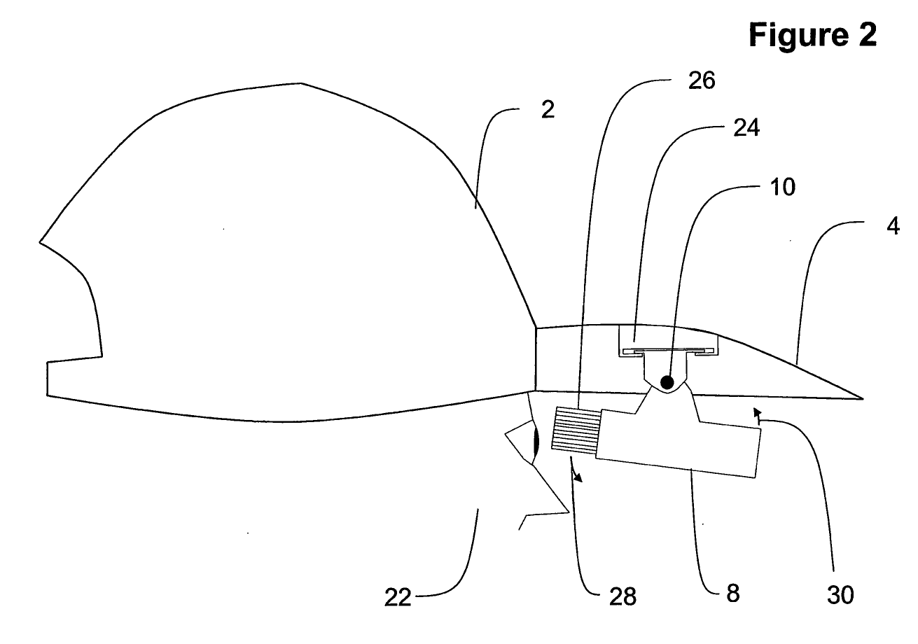

FIG. 1 illustrates a cap with an viewing device accessory detachably mounted thereto in accordance with one embodiment of the invention.

FIG. 2 illustrates a side view of a cap with a viewing device accessory in the in use position according to one embodiment of the invention.

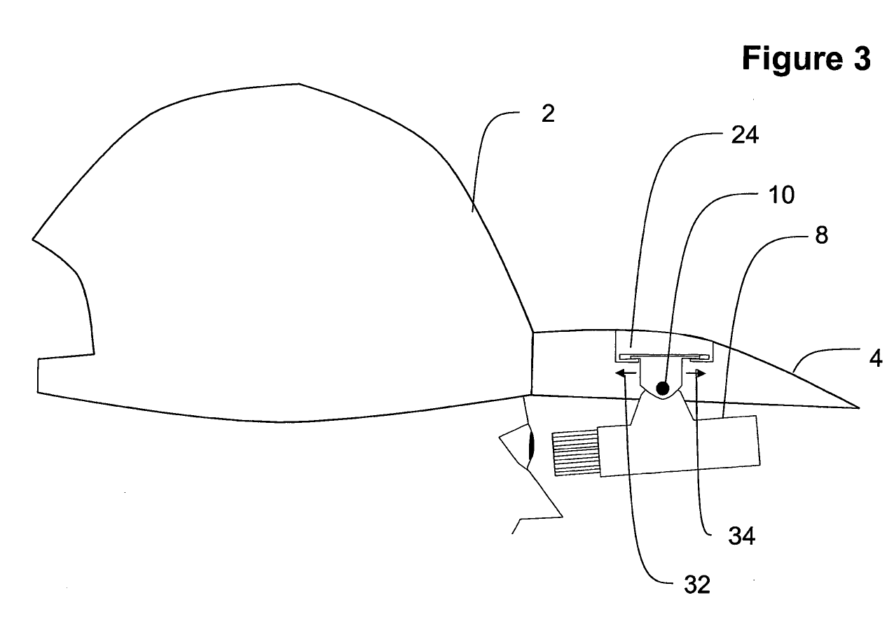

FIG. 3 illustrates a side view of a cap with a viewing device accessory in the out of use position according to one embodiment of the invention.

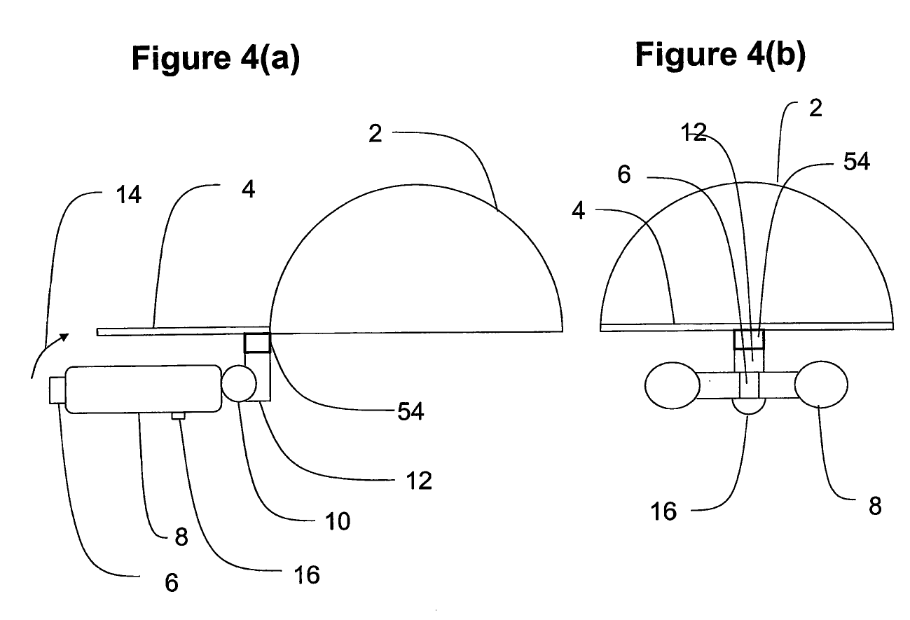

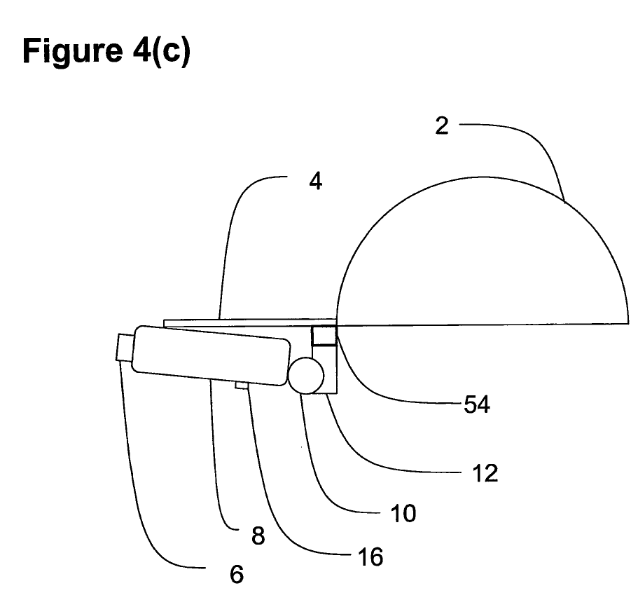

FIG. 4 illustrates a cap with a viewing device accessory according to one embodiment of the invention (a) from the side in an in-use position (b) from the front in an in-use position (c) from the side in an out-of-use position.

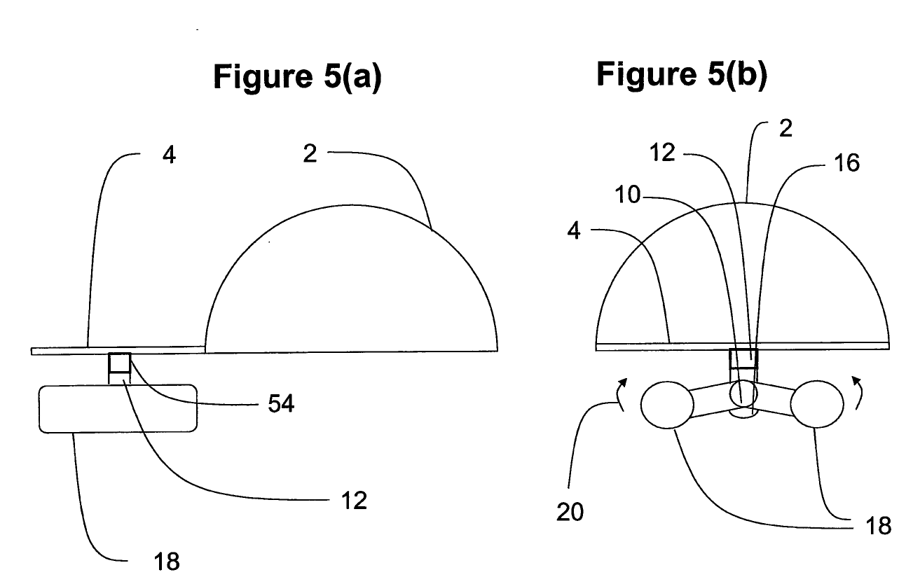

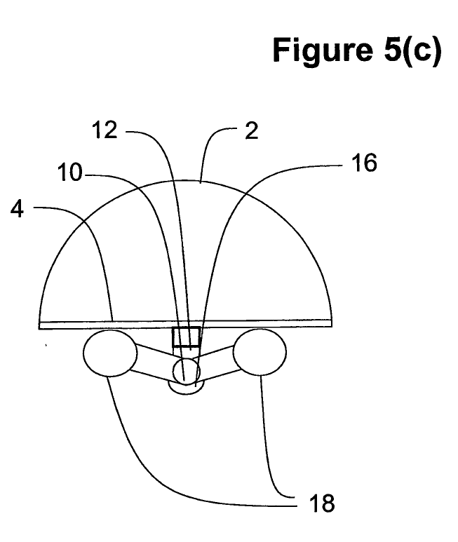

FIG. 5 illustrates a cap with a viewing device accessory according to a second embodiment of the invention (a) from the side in an in-use position (b) from the front in an in-use position (c) from the side in an out-of-use position.

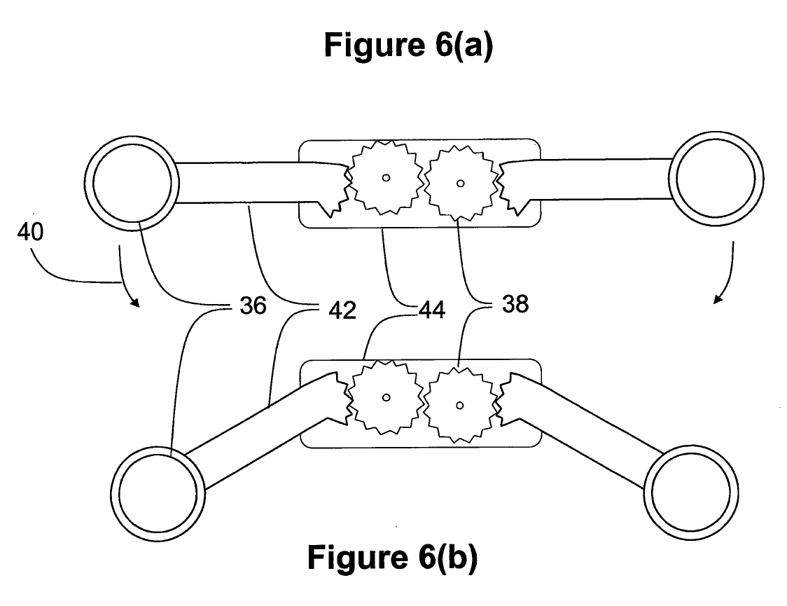

FIGS. 6-8 illustrate a cross-sectional schematic view of the viewing device accessory (a) in the out of use position (b) in the in-use position.

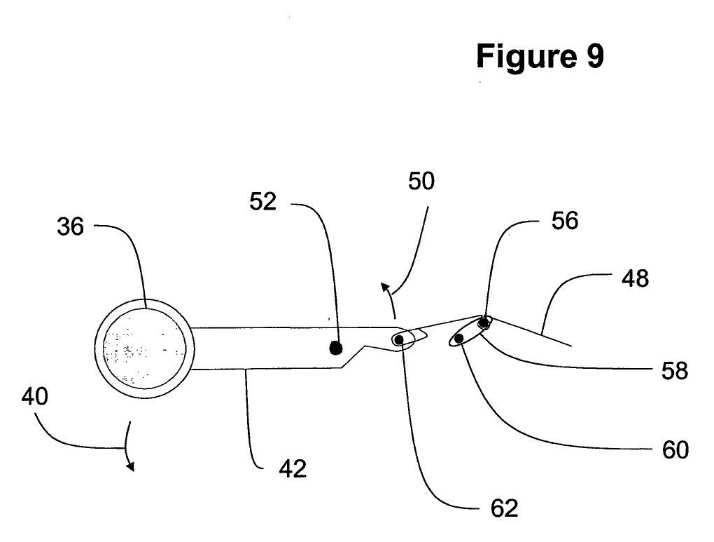

FIG. 9 illustrates a cross-sectional schematic view of an alternative viewing device accessory in the out of use position.

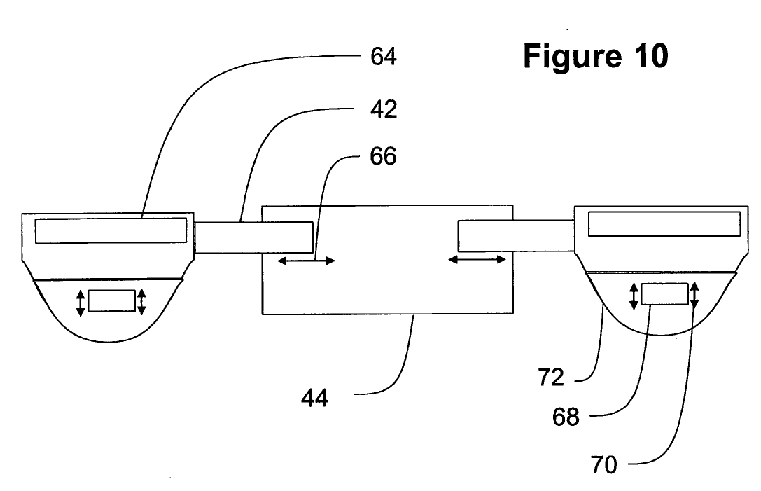

FIG. 10 illustrates a viewing device according to a further embodiment of the invention from above.

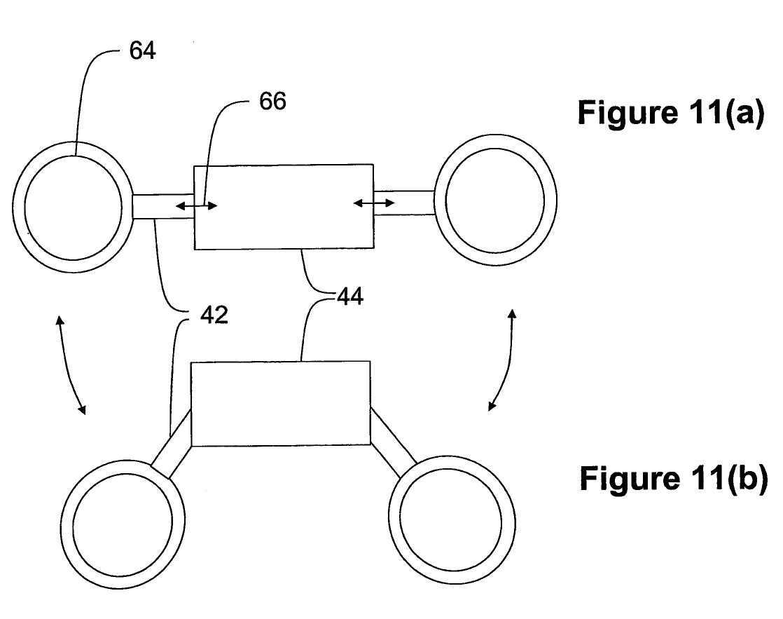

FIG. 11 illustrates the viewing device of FIG. 10 from the front (a) in an out-of-use position and; (b) in an in-use position.

With reference to FIGS. 1-3, there is illustrated a baseball cap with a visor 4 for shielding the wearer's eyes from light and a cloth body section 2, worn on the head of a user 22.

The visor 4 is provided with a mounting device including mounting means in the form of tilt/slide mechanism 24, and attachment means 54 comprising a strap of hook and loop fastenings, allowing the mounting device to be detachably attached to the visor 4. Alternatively the mounting device can be fixedly attached to the visor 4, as illustrated in FIGS. 2-3.

The tilt/slide mechanism 24 allows at least one accessory such as a viewing device in the form of binoculars 8 to be connected thereto. The binoculars 8 are pivotally mounted on the tilt/slide mechanism 24 via pivoting means 10.

When in the in-use position, each objective of the binoculars 8 is located in front of the wearer's eyes, in their line of sight, such that they are able to view distant objects through the same. The user is able to adjust the focus of each or both objectives by adjusting the focusing eyepiece 26.

The binoculars 8 may be moved to an out-of-use position by pivoting the same as indicated by the arrows 28, 30. This pivots the binoculars 8 so that the objectives are no longer in the line-of-sight. An angle of about 20° is sufficient to pivot the binoculars our of the viewer's line of sight.

The binoculars 8 may also be moved backwards and forwards by using the sliding mechanism 24, as indicated by the arrows 32, 34 respectively.

The tilt/slide mechanism 24 and/or binoculars 8 may be interchanged with other accessories as required. For example mounting means could be provided in the form of a customised docking unit (not shown) and an MP3 player could be connected thereto. The MP3 player could be provided with batteries, or draw power from a power supply connected to the mounting device.

With reference to FIGS. 4a-c, there is illustrated an alternative embodiment of the mounting device connected to the baseball cap, which includes attachment means 54 and a support 12, and the binoculars 8 are pivotally mounted on the support via pivoting means 10. When in the in-use position, each objective of the binoculars is located in front of the wearer's eyes, in their line of sight, such that they are able to view distant objects through the same. The user is able to adjust the focus of each or both objectives by adjusting the focus wheel 16.

The binoculars 8 may be moved to an out-of-use position by lifting one end of the same as indicated by the arrow 14, from a configuration as indicated in FIGS. 4a-b, to that shown in FIG. 4c. This pivots the binoculars 8 so that the objectives are no longer in the line-of-sight. An angle of about 20° is sufficient to pivot the binoculars our of the viewer's line of sight. Furthermore, the support is located centrally, between the viewer's eyes so that it does not interfere with the viewer's line of sight.

The binoculars are provided with a bracket 6, and further accessories such as night-vision devices may be mounted thereon. The functionality of the night-vision device can be combined with the binoculars 8 so that, for example, the user can view and zoom in on distant objects at night. The bracket 6 may be located at other positions, depending on the accessory to be mounted.

Referring to FIGS. 5a-c, there is illustrated a mounting device for a baseball cap similar to that shown in FIGS. 4a-c, provided with a viewing device accessory with viewing means in the form of individual telescopes 18. The telescopes 18 can be moved from an in-use position to an out-of-use position by pivoting longitudinally around the pivoting means 10. This movement defines an arcuate path as indicated by arrow 20, during which the telescopes 18 maintain their substantially horizontal orientation. The telescopes 18 are thereby lifted completely out of the line of sight of the viewer.

Referring to FIGS. 6a-b, the mounting device includes a support 44 connecting the telescopes or objectives 36 via arms 42. The support 44 contains rotatably mounted cogs or gears 38, such that when one of the objectives is moved, equivalent simultaneous movement of the other objective occurs, as indicated by arrow 40. Thus the user only needs to handle one objective to move both objectives 36 from an out of use position as indicated by FIG. 6a to the in use position shown in FIG. 6b.

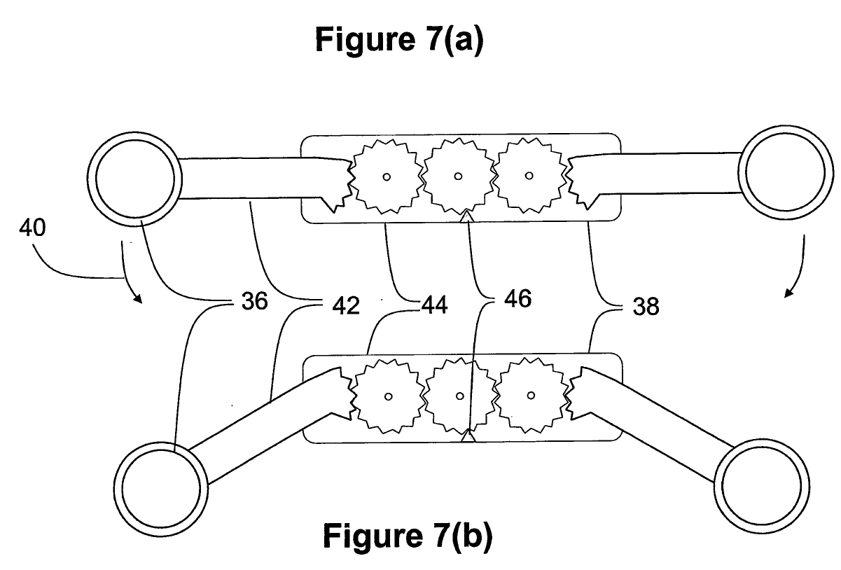

With reference to FIGS. 7a-b, a similar mechanism is depicted to that shown in FIGS. 6a-b, further including a ratchet mechanism 46 so that the arms index or click as they are adjusted between the in use and out of use positions.

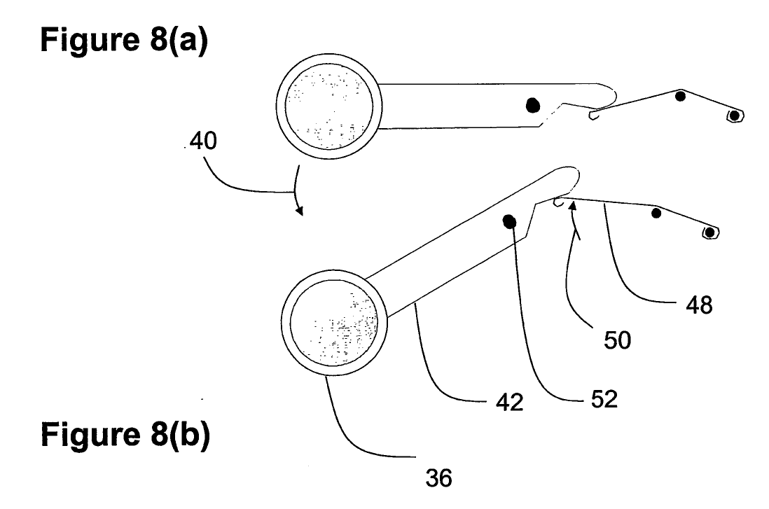

Referring to FIGS. 8a-b, one half of the mechanism is shown between the two objectives. The objective 36 is biased towards an in use position as shown in FIG. 8b by a spring 48. The spring is under tension when the viewing means are in the out-of use position as shown in FIG. 8a, and when released, forces the end of the arm 42 to pivot upwards as indicated by arrow 50 around pivot point 52, thereby moving the distal end of the arm 42 and objective 36 generally downwards as indicated by arrow 40.

As shown in FIG. 9, the mechanism of FIG. 8 may include a cam 58, pivotally mounted at pivot point 60, and connected to the spring by a pin 56. The spring is connected to the objective 36 by a further pin 62. As the cam is pivoted upwards, the end of the spring 48 connected to pin 62 is lifted and in turn biases the objective 36 to an in-use position.

Referring to FIGS. 10-11, the viewing device accessory includes lenses 64 on the ends of arms 42. The arms 42 may move in and out of a housing 44 as shown by arrows 66, to allow adjustment of the distance between the lenses 64. The device may further include Organic Light Emitting Diode (OLED) displays 68 to provide alternative or additional views of objects. The position of the OLED display 68 may be adjusted relative to the lens 64 to focus the same, as indicated by arrows 70, by rotation of a portion 72 of the casing.

In this embodiment the mechanism in the housing between the arms can be similar to that hereinbefore described. Typically, end-stop positions are fixed for in-use and out-of-use positions. The OLED display 68 may be aligned for the in-use position only, and once the position is established no further positioning should be necessary.

In use, the user may wish to watch a sport where the players are substantially located in the distance, such as cricket or baseball. A mounting device can be used to attach a viewing device accessory to a baseball cap, which can then be worn on the user's head. The viewing device accessory can be moved between in-use and out-of-use positions as required, either manually or by using a wired or wireless remote control. The wearer, may also detach at least part of the viewing device accessory or simply turn the cap around if they do not wish to use the viewing means.

It will be appreciated by persons skilled in the art that the present invention also includes further additional modifications made to the device which does not effect the overall functioning of the device, such as the provision of decoration, a fabric or plastic covering to provide improved aesthetic appearance, and/or the like.

1. A mounting device including attachment means which are attachable to or provided as part of a wearable item, and mounting means for attaching at least one accessory thereto to allow said accessory to be supported by the wearable item.

2. A mounting device according to claim 1 characterised in that there is provided tilting means which permit the wearer to adjust the angle of an accessory independently to the angle of presentation of the wearable item

3. A mounting device according to claim 1 or 2 characterised in that sliding means are provided to adjust the distance of an accessory from the wearer.

4. A mounting device according to claim 1 characterised in that a ball and socket joint is provided to allow a full range of movement of the accessory connected thereto.

5. A mounting device according to claim 1 characterised in that at least one accessory is a viewing device include any or any combination of optical and/or electronic viewing means

6. A mounting device according to claim 1 characterised in that at least one accessory is an imaging device including any or any combination of cameras, video cameras, or electronic displays.

7. A mounting device according to claim 1 characterised in that the at least one accessory is an audio device including any or any combination of media players, media recorders, radios, speakers, or microphones.

8. A mounting device according to claim 1 characterised in that at least one accessory is a proximity device which alerts the user audibly and/or by vibration when the wearable item and/or user is in proximity to another user or object.

9. A mounting device according to claim 1 chatacterised in that at least one accessory is a charging device in the form of a solar cell panel to enable the user to recharge batteries of an accessory connected thereto.

10. A mounting device according to claim 1 characterised in that the accessories are battery powered and function independently of the wearable item and mounting device.

11. A mounting device according to claim 1 characterised in that the accessories attach to a docking plate via a docking unit.

12. A mounting device according to claim 11 characterised in that the docking unit includes any or any combination of audio amplifiers, data display panels, heads-up displays, wireless remote control links, and additional batteries.

13. A viewing device including viewing means connected to mounting means, and attachment means for attaching the device to a wearable item, characterised in that said viewing means can be moved selectively between an in-use position in which the same are positioned in the vicinity of at least one of the wearer's eyes and an out of use position moved away from the in use position.

14. A viewing device according to claim 13 characterised in that the viewing means include any or any combination of optical and/or electronic viewing means.

15. A viewing device according to claim 13 characterised in that pivoting means are provided to allow the viewing means to be pivoted between the in-use and out-of-use positions and/or to allow interocular adjustment.

16. A viewing device according to claim 13 characterised in that the viewing means includes a gear driven adjustment system and/or drive means to operate movements of the same, including any or any combination of switching between in-use and out-of-use positions, spacing of the viewing means relative to the user's eyes, focusing, tilting, zooming, end-stop location.

17. A viewing device according to claim 13 characterised in that the movement of the viewing means is limited by adjustable end-stops which define the range of movement allowed of the viewing means between in-use and out-of-use positions, and/or allow inter-ocular spacing adjustments.

18. A viewing device according to claim 16 characterised in that a ratchet mechanism is provided which locks the adjustment system when a particular position is reached, and can be released electronically or manually.

19. A viewing device according to claim 16 characterised in that the adjustment system is provided with a spring loaded mechanism that permits quick movement between in-use and out-of-use positions.

20. A viewing device according to claim 19 characterised in the viewing means can be locked in an out-of-use position by a latch or button connected thereto, and on actuating the same, the spring biases the viewing means towards the in-use position.

21. A viewing device according to claim 19 characterised in that the tension in and/or strength of the spring can be adjusted.

22. A viewing device according to claim 13 characterised in that switching means are provided to allow the configuration of the viewing means to be remotely controlled.

23. A viewing device according to claim 13 characterised in that the viewing means includes two telescopes which are moved in mirrored arcuate paths.

24. A viewing device according to claim 23 characterised in that movement of one telescope brings about corresponding movement of the other telescope, or alternatively, each telescope can be moved independently, which would allow the user to compensate for uneven mountings of the same.

25. A viewing device according to claim 23 characterised in that the viewing means includes focusing means for adjusting the focus of the telescopes, and/or zoom lens means for adjusting the magnification of viewed objects.

26. A viewing device according to claim 25 characterised in that the focus of the each telescope is adjusted independently of the other.

27. A viewing device according to claim 13 characterised in that the viewing range or focus range of the viewing means is adjustable by altering the optical path length of the viewing means.

28. A viewing device according to claim 13 characterised in that the viewing means is provided with a casing, and any rotary and/or linear movement of said casing results in a change of the optical path length of the viewing means.

29. A viewing device according to claim 13 characterised in that imaging means and/or storage means are provided for the capture of still and/or video images, and/or accompanying sound.

30. A viewing device according to claim 29 characterised in that a sharp focus image is provided both to the eye of a user and the sensor of the imaging means.

31. A viewing device according to claim 29 characterised in that when the viewing means are moved between in use and out of use positions, a mechanism is provided so that the imaging means and/or images derived therefrom do not rotate.

32. A viewing device according to claim 29 characterised in that two or more imaging means can be provided to allow three dimensional capture of both still and/or video images and/or sound.

33. A viewing device according to claim 13 characterised in that the device is manufactured to be lightweight and/or disposable.

34. A wearable item including a cap or band having a body portion to be worn on the head, and a visor protruding from the front end of the cap or band when worn, said visor including attachment means, optical viewing means connected to the attachment means via mounting means, and characterised in that said viewing means can be moved selectively between an in-use position in which the same are positioned in the vicinity of at least one of the wearer's eyes and an out of use position moved away from the in use position.

35. A wearable item according to claim 34 characterised in that the body portion include sizing means for adjusting the fit of the cap or band around a wearer's head, and the visor includes strengthening means to ensure support for the viewing means.

36. A wearable item according to claim 34 characterised in that the attachment means are slidably attached to the cap or band to allow lateral linear or circumferential movement of the viewing means to the side of the wearer's eyes, to an out-of-use position.

37. A wearable item according to claim 34 characterised in that the visor is pivotally connected to the body portion of the cap and the attachment means are connected to the visor such that the viewing means is moved between in-use and out-of-use positions by adjusting the position of the visor with respect to the portion of the cap which is worn.

38. A wearable item according to claim 34 characterised in that the attachment means and/or mounting means are located centrally with respect to the visor and the wearer's eyes, so that there is no or minimal interference to the line of sight by the same when the viewing means are in their in-use and/or out-of-use positions.

39. A wearable item including means for attaching one or more accessories thereto, said accessories including any or any combination of viewing, imaging and audio devices.
